(19) United States
(12) Patent Application Publication
(10) Pub. No.: US 2026/0257592 A1
(43) Pub. Date: Sep. 3, 2026

(54) VEHICLE SEAT

(71) Applicant: Adient US LLC, Plymouth, MI (US)

(72) Inventors: Viktor ENNS, Kaiserslautern (DE); Erik DICK, St. Julian (DE); Thomas DILL, Heiligenmoschel (DE)

(73) Assignee: Adient US LLC, Plymouth, MI (US)

(21) Appl. No.: 18/866,225

(22) PCT Filed: May 11, 2023
(86) PCT No.: PCT/IB2023/054857

§ 371 Date: Nov. 15, 2024

(30) Foreign Application Priority Data
May 16, 2022 (DE) 10 2022 112 156.9
Aug. 4, 2022 (DE) 10 2022 119 627.5

(51) Int. Cl. B60N 2/18

(52) U.S. Cl. CPC B60N 2/1803; B60N 2/1814; B60N 2/1817; B60N 2/1853

(57) ABSTRACT

A vehicle seat may have a seat substructure and a backrest articulated to the seat substructure. The seat substructure may have a base, a seat frame and an adjustment kinematics system which acts between the base and the seat frame for providing a height-adjustment function and for transferring the seat frame and the backrest into an inclined position. The adjustment kinematics system is designed as a five-bar linkage kinematics system. The vehicle seat may have a first actuator for providing the height-adjustment function and a second actuator for transferring the seat frame and the backrest into the inclined position. An angle between the second front rocker and the seat frame can be changed to transfer the seat frame and the backrest into the inclined position by the second actuator. The second actuator may have an electric motor, a gear mechanism, a spindle nut and a spindle.

The invention relates to a vehicle seat, in particular for an autonomously driving motor vehicle, the vehicle seat having a seat substructure and a backrest which is articulated to the seat substructure, the seat substructure having a base, a seat frame and an adjustment kinematic system which acts between the base and the seat frame for performing a height adjustment function and for moving the seat frame and the backrest into an inclined position, wherein the adjustment kinematic system is in the form of a five-bar kinematic system having a first front link, a second front link and a rear link, wherein the first front link is articulated to the base pivotably about a first rotation axis, the second front link is articulated to the first front link pivotably about a second rotation axis, the second front link is articulated to the seat frame pivotably about a third rotation axis, the rear link is articulated to the seat frame pivotably about a fourth rotation axis and the rear link is articulated to the base pivotably about a fifth rotation axis, wherein the vehicle seat has a first actuation drive for performing the height adjustment function and has a second actuation drive for moving the seat frame and the backrest into the inclined position, wherein, in order to move the seat frame and the backrest into the inclined position by the second actuation drive, an angle between the second front link and the seat frame is variable.

### PRIOR ART

DE 10 2018 122 198 A1 discloses an actuation drive for a motor vehicle, in particular for a motor vehicle seat, having an electric motor which has an output shaft; a gear mechanism which has a spindle nut and a gear mechanism housing and which is connected to the output shaft; having a spindle which is in engagement with the spindle nut and having a retention member which at least partially encloses the gear mechanism housing.

WO 2020/207835 A1 discloses a vehicle seat having a height adjustment kinematic system, the height adjustment kinematic system having at each of two seat sides which are arranged offset relative to each other in a transverse direction a four-bar arrangement and an adjustment arm, respectively, each of the two four-bar arrangements having a base, a side portion, a front link and a rear link acting as gear mechanism members of the four-bar arrangement, wherein a first rotary articulation connects the base pivotably to the rear link, a second rotary articulation connects the rear link pivotably to the side portion, a third rotary articulation connects the side portion pivotably to the front link and a fourth rotary articulation connects the front link pivotably to the base, wherein each of the two four-bar arrangements is adjustable by one of the two adjustment arms, wherein a drive apparatus having precisely one gear mechanism motor drives the two adjustment arms.

WO 2020/114946 A1 discloses a longitudinal adjuster for a vehicle seat having at least one rail pair which has a seat rail, which can be connected to the vehicle seat, and a floor rail, which can be connected to a vehicle floor and on which the seat rail is displaceably guided in a longitudinal direction. The longitudinal adjuster has a drive device for adjusting the seat rail in the longitudinal direction relative to the floor rail, wherein the drive apparatus has a spindle which is fixed to the floor rail or the seat rail, a rotatable spindle nut which is supported on the spindle via a thread engagement and an electric motor which is actively connected to the spindle nut for driving the spindle nut. An output shaft of the electric motor at the output side is orientated parallel with the spindle.

DE 198 08 235 C1 discloses a vehicle seat having a seat substructure and a backrest which is articulated to the seat substructure, the seat substructure having a base, a seat frame and an adjustment kinematic system which acts between the base and the seat frame, wherein the adjustment kinematic system is in the form of a five-bar kinematic system, wherein the adjustment kinematic system has a first front link, a second front link and a rear link, wherein the first front link is articulated to the base pivotably about a first rotation axis, the second front link is articulated to the first front link pivotably about a second rotation axis, the second front link is articulated to the seat frame pivotably about a third rotation axis, the rear link is articulated to the seat frame pivotably about a fourth rotation axis and the rear link is articulated to the base pivotably about a fifth rotation axis, wherein the adjustment kinematic system has a first actuation drive for performing a height adjustment function, wherein, in order to provide an angular position of the seat frame and the backrest, an angle between the second front link and the seat frame is variable by a second actuation drive. The first actuation drive has an actuation motor having an adjusting spindle. The second actuation drive is in the form of a self-locking rotary adjuster.

DE 10 2008 053 475 A1 discloses an adjustable vehicle seat having a seat member which is adjustable in terms of inclination by a five-bar kinematic system and a backrest which is adjustable in terms of inclination and which is supported in the seat member. During a change of the inclination of the seat member, the backrest angle is compensated for so that the backrest always has an unchanged inclination, whereby the occupant can substantially retain his/her supported back inclination in the changed position of the bottom and upper leg support. In one embodiment, a bearing element of the five-bar kinematic system is in the form of a link which can change its length and which is variable in terms of its length by an electromotive adjustment system, in particular an electric spindle drive.

CN 1 13 212 258 A and US 2019/0 308 527 A1 also disclose a vehicle seat having an adjustment kinematic system which is in the form of a five-bar kinematic system. DE 101 35 857 C1 discloses a motor vehicle seat member having a seat frame and a seat upholstery region which is adjustable in terms of inclination and which has a motor drive via a spindle and spindle nut which is supported on a pivotable lever in an articulated manner. The lever is connected in a rotationally secure manner to a shaft which extends transversely relative to the seat member and on which there is provided an actuation region which is radially offset relative to the pivot axis thereof and which is connected in an articulated manner to the seat upholstery region which is adjustable in terms of inclination. The seat member is adjustable in terms of height by a four-bar kinematic system which is configured separately from the seat upholstery region which is adjustable in terms of inclination.

In an autonomously driving motor vehicle, a vehicle driver does not have to or does not constantly have to carry out steering and/or braking and acceleration activities during operation of the motor vehicle, but instead the motor vehicle can be operated independently of the actions of a vehicle driver. The vehicle driver can therefore take up a more comfortable position during autonomous driving than in conventional vehicles. DE 10 2018 203 731 A1 discloses a vehicle seat, in particular for an autonomously driving motor vehicle, which can take up an inclined position in which a seat member and a backrest have an angle which allows a partially reclined position of the vehicle occupant during autonomous driving operation. In an upright position of the vehicle seat, the vehicle driver can take over the driving of the vehicle if the autonomous driving operation is switched off.

### Problem

The problem addressed by the invention is to provide a vehicle seat, in particular for an autonomously driving motor vehicle, which can take up an inclined position, in which a seat member and a backrest have an angle which allows a partially reclined position of a vehicle occupant, in particular vehicle driver, in particular during autonomous driving operation. In particular, the vehicle seat is also intended, in addition to the possibility of taking up an inclined position, to have a seat height adjuster and preferably also a seat face inclination adjuster.

The difference between a seat face inclination adjustability and the provision of an inclined position involves a change of an inclination angle of the seat face taking place in the case of a seat face inclination adjustment, whereas an inclination angle of the backrest is not changed while both the inclination angle of the seat face and the inclination angle of the backrest are changed when an inclined position is taken up.

### Solution

This problem is solved according to the invention by a vehicle seat, in particular for an autonomously driving motor vehicle, the vehicle seat having a seat substructure and a backrest which is articulated to the seat substructure, the seat substructure having a base, a seat frame and an adjustment kinematic system which acts between the base and the seat frame for performing a height adjustment function and for moving the seat frame and the backrest into an inclined position, wherein the adjustment kinematic system is in the form of a five-bar kinematic system having a first front link, a second front link and a rear link, wherein the first front link is articulated to the base pivotably about a first rotation axis, the second front link is articulated to the first front link pivotably about a second rotation axis, the second front link is articulated to the seat frame pivotably about a third rotation axis, the rear link is articulated to the seat frame pivotably about a fourth rotation axis and the rear link is articulated to the base pivotably about a fifth rotation axis, wherein the vehicle seat has a first actuation drive for performing the height adjustment function and has a second actuation drive for moving the seat frame and the backrest into the inclined position, wherein, in order to move the seat frame and the backrest into the inclined position by the second actuation drive, an angle between the second front link and the seat frame is variable, wherein the second actuation drive has an electric motor, a gear mechanism, a spindle nut and a spindle.

In that the second actuation drive has an electric motor, a gear mechanism, a spindle nut and a spindle, in particular a self-locking rotary adjuster for providing the third rotation axis can be dispensed with. The third rotation axis can thereby be positioned in a higher position than in the prior art so that a greater change of the inclination angles of the seat face and backrest can be carried out. The third rotation axis can be formed by rotary bearings which save construction space and which take up less structural space than, for example, self-locking rotary adjusters, as used in the vehicle seat known from DE 198 08 235 C1. Furthermore, the configuration of the second actuation drive as a spindle drive provides a particularly good adjustment speed with low noise and high strength.

A first end region of the first front link can be articulated to the base pivotably about the first rotation axis. A first end region of the second front link can be articulated to a second end region of the first front link pivotably about the second rotation axis. A second end region of the second front link can be articulated to the seat frame pivotably about the third rotation axis. A first end region of the rear link can be articulated to the seat frame pivotably about the fourth rotation axis. A second end region of the rear link can be articulated to the base pivotably about the fifth rotation axis.

The first rotation axis can be arranged under the second rotation axis. The first rotation axis can be arranged under the third rotation axis. The first rotation axis can be arranged in front of the fourth rotation axis. The first rotation axis can be arranged in front of the fifth rotation axis.

The second rotation axis can be arranged under the third rotation axis. The second rotation axis can be arranged in front of the fourth rotation axis. The second rotation axis can be arranged in front of the fifth rotation axis.

The third rotation axis can be arranged in front of the fourth rotation axis. The third rotation axis can be arranged in front of the fifth rotation axis. The fifth rotation axis can be arranged under the fourth rotation axis.

Particularly in order to perform the height adjustment function, an angle between the first front link and the base and an angle between the rear link and the base may be variable by the first actuation drive. In this case, an angle between the second front link and the seat frame preferably remains constant.

Preferably, the spindle of the second actuation drive is articulated to the second front link eccentrically relative to the second rotation axis. An end region of the spindle of the second actuation drive can be articulated to the second front link eccentrically relative to the second rotation axis. The spindle of the second actuation drive can be articulated to the first front link eccentrically relative to the second rotation axis. The spindle of the second actuation drive can be connected to the first front link and the second front link in the second rotation axis. Preferably, the spindle of the second actuation drive is articulated to the second front link eccentrically relative to the third rotation axis.

The spindle of the second actuation drive can be articulated to the second front link under the third rotation axis. Preferably, an end region of the spindle of the second actuation drive is articulated to the second front link under the third rotation axis. As a result, more upholstery material can be arranged between the third rotation axis and an occupant of the vehicle seat and the seat comfort can thereby be increased.

The third rotation axis is preferably arranged in front of the second rotation axis so that, in the event of an overload, for example, a front-end crash, the second rotation axis is moved away from the legs of an occupant of the vehicle seat and a risk of injury is thereby reduced.

The third rotation axis is preferably arranged in front of the first rotation axis. The risk of injury, in particular to feet of an occupant of the vehicle seat, is thereby reduced.

By a spacing between the second rotation axis and the third rotation axis being greater than a spacing between the first rotation axis and the second rotation axis, particularly great inclination angles can be achieved during the transition into the inclined position.

The electric motor of the second actuation drive and the gear mechanism of the second actuation drive can be arranged completely below the third rotation axis. In comparison with a second actuation drive, which is formed by a self-locking rotary adjuster, more upholstery material can thereby be arranged between the third rotation axis and an occupant of the vehicle seat and the seat comfort can thereby be increased.

When changing the seat frame and the backrest into the inclined position, an inclination angle of the seat face relative to the vertical direction can be changed by the same amount as an inclination angle of the backrest relative to the vertical direction.

The first actuation drive can have an electric motor and a gear mechanism. The first actuation drive can have an electric motor, a gear mechanism, a spindle nut and a spindle. The first spindle drive can connect the rear link and the base to each other in an angularly adjustable manner. The first actuation drive can connect the rear link and the base in an angularly adjustable manner and directly, that is to say, without any intermediate connection of additional gear mechanism members. A spindle of the first actuation drive can be articulated to the rear link pivotably between the fourth rotation axis and the fifth rotation axis, wherein the gear mechanism of the first actuation drive can be secured to the base.

The electric motor of the first actuation drive and/or the gear mechanism of the first actuation drive are preferably arranged in front of the fourth rotation axis, whereby foot room under the vehicle seat is optimized for passengers of a row of seats arranged behind the vehicle seat.

A spindle of the second actuation drive can be pivotably articulated to a connection pipe, which connects the two front links to each other, eccentrically relative to the third rotation axis, wherein the gear mechanism of the first actuation drive can be secured to the seat frame.

In particular for providing a seat face inclination adjuster, a seat face upholstery carrier can be pivotably articulated to the seat frame, in particular about a sixth rotation axis. An angle between the seat face upholstery carrier and the seat frame may be adjustable by a third actuation drive.

The sixth rotation axis can be arranged behind the first rotation axis. The sixth rotation axis can be arranged behind the second rotation axis. The sixth rotation axis can be arranged behind the third rotation axis. The sixth rotation axis can be arranged in front of the fourth rotation axis. The sixth rotation axis can be arranged in front of the fifth rotation axis.

The base may have an adapter. The adapter can be formed or secured on a seat rail of a base which is in the form of a longitudinal adjuster. The longitudinal adjuster may have at least one seat rail and one floor rail which can be connected to a vehicle floor and on which the seat rail is displaceably guided. The longitudinal adjuster may have a fourth actuation drive for displacing the seat rail relative to the floor rail.

In summary and in other words, the invention provides a vehicle seat having a relax function (tilting of the entire vehicle seat about a rear axis near the floor about, for example, up to 20 degrees), with one or two spindle drives. A height adjustment drive which can be supported in a manner secured to rails and which drives only the rear link can be combined therewith. Both drives can preferably be actuated independently of each other. It is possible as a result of the invention to implement an extremely low block dimension, in particular approximately 171 mm. The term “block dimension” is intended to be understood to be a spacing from a theoretical sitting location, also referred to as the H (hip) point, which is specific to the vehicle, in the lowest position of a height adjustment of the vehicle seat relative to the vehicle floor.

### FIGURES AND EMBODIMENTS OF THE INVENTION

The invention is explained in greater detail below with reference to an advantageous exemplary embodiment which is illustrated in the figures. However, the invention is not limited to this exemplary embodiment. In the drawings:

FIG. 1: shows a highly schematic side view of a vehicle seat according to the invention,

FIG. 2: shows a perspective view of a vehicle seat according to the invention in a non-upholstered state,

FIG. 3: shows a plan view of the vehicle seat from FIG. 2,

FIG. 4: shows a side view of the vehicle seat from FIG. 2, wherein the vehicle seat is in a lower height adjustment position and an upright position,

FIG. 5: shows a side view of the vehicle seat from FIG. 2, wherein the vehicle seat is in an upper height adjustment position and an upright position,

FIG. 6: shows a side view of the vehicle seat from FIG. 2, wherein the vehicle seat is in an upper height adjustment position and an inclined position,

FIG. 7: shows a perspective view of the vehicle seat from FIG. 2, wherein the vehicle seat is in an upper height adjustment position and an inclined position,

FIG. 8: shows a side view of the vehicle seat from FIG. 2, wherein the vehicle seat is in a lower height adjustment position and an inclined position,

FIG. 9: shows a perspective view of the vehicle seat from FIG. 2, wherein the vehicle seat is in a lower height adjustment position and an inclined position, and

FIG. 10: shows another perspective view of the vehicle seat from FIG. 2, wherein the vehicle seat is in a lower height adjustment position and an inclined position.

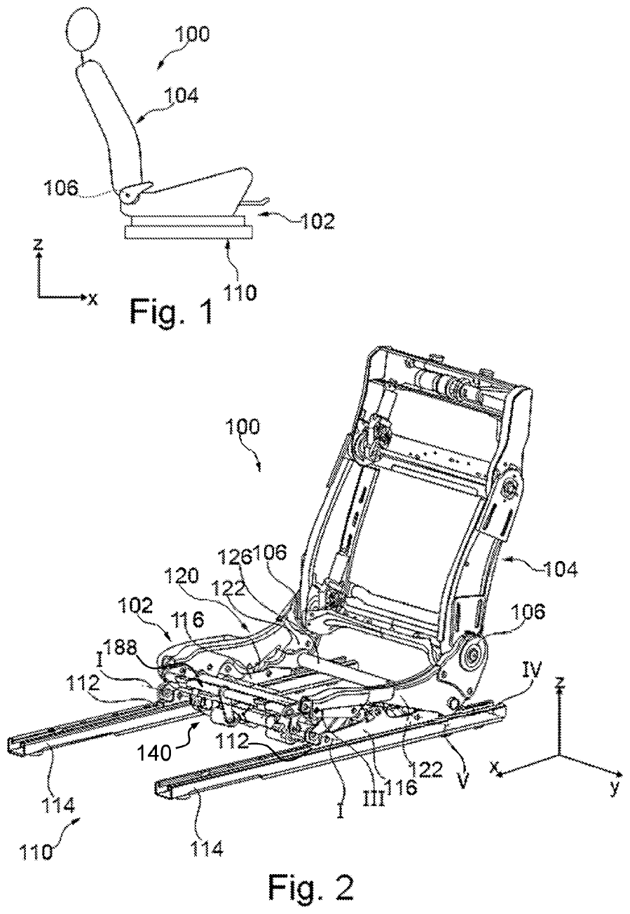

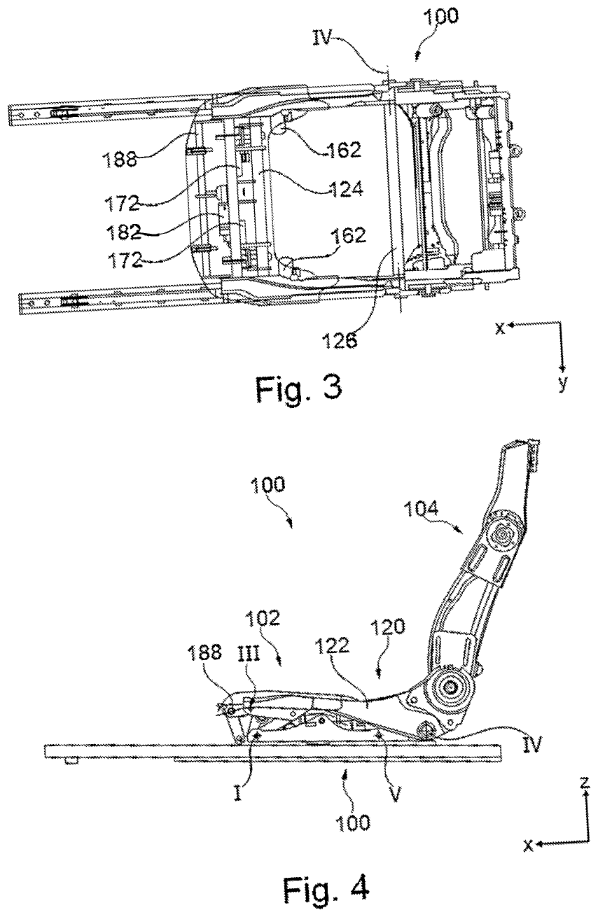

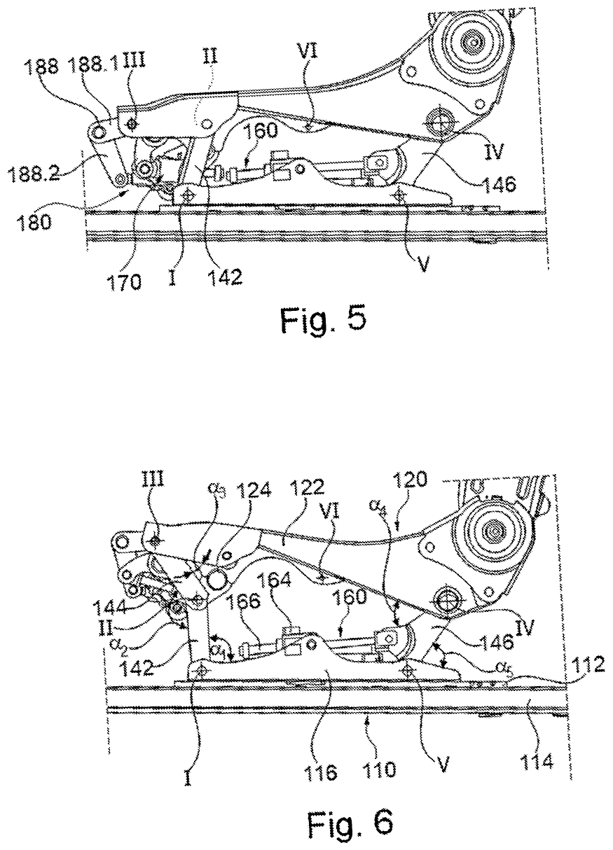

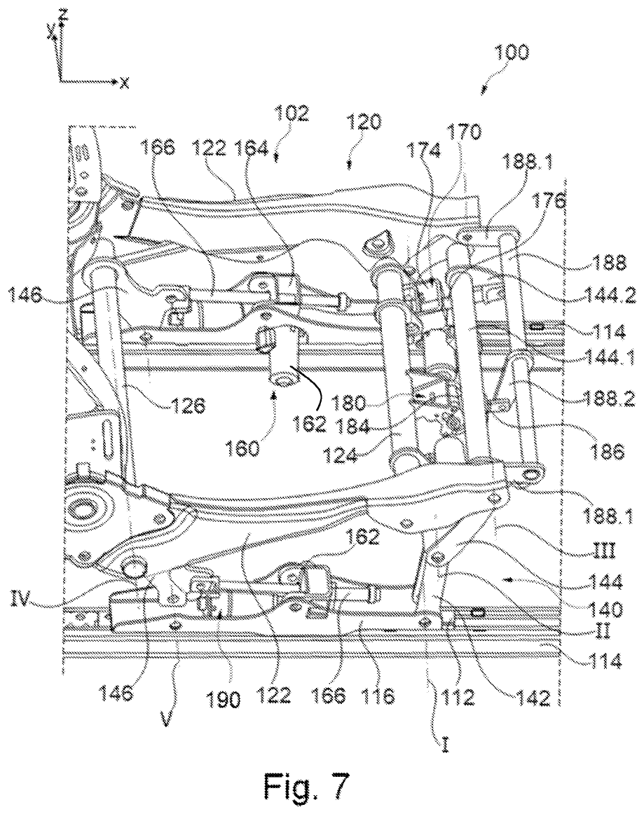

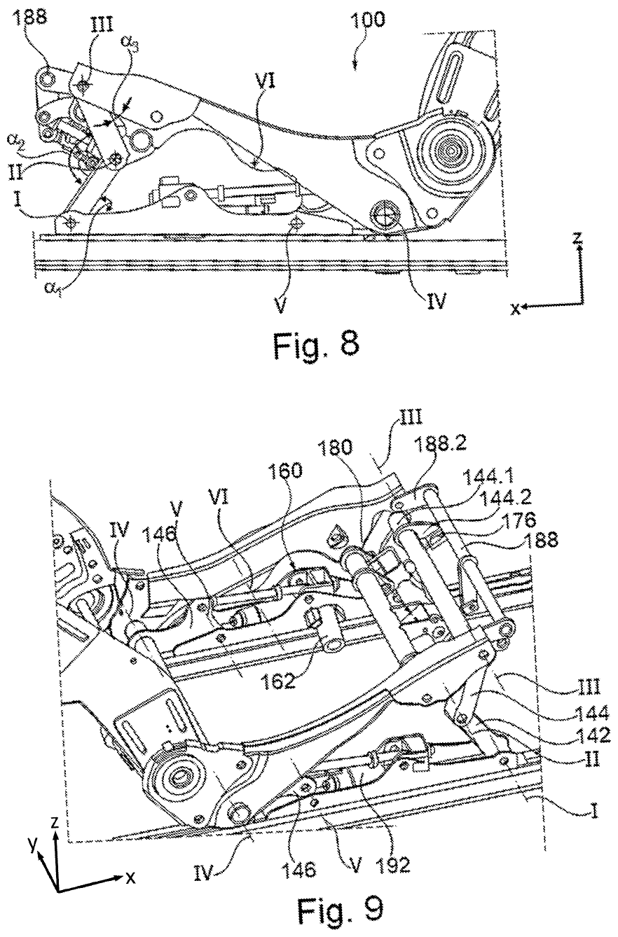

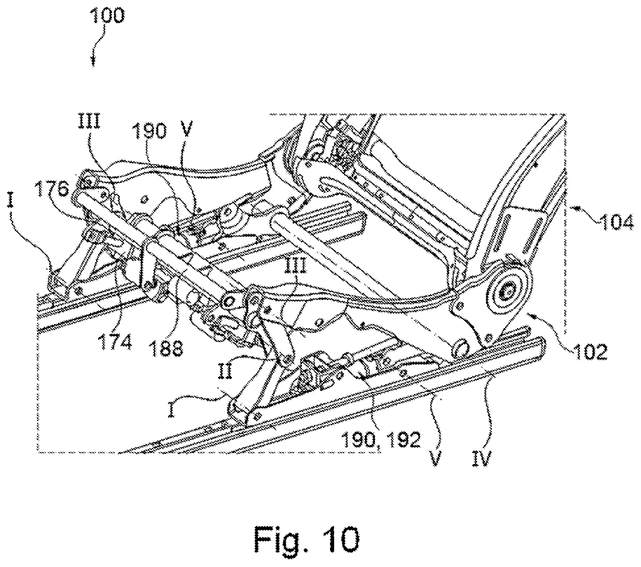

FIGS. 1 to 10 show a vehicle seat 100 according to the invention according to one exemplary embodiment, wherein the vehicle seat 100 is illustrated in FIG. 1 in a highly schematic manner.

The vehicle seat 100 is described below using three mutually perpendicularly extending spatial directions. A longitudinal direction x extends in a vehicle seat 100 which is fitted in the vehicle substantially horizontally and preferably parallel with a longitudinal vehicle direction which corresponds to the usual travel direction of the vehicle. A transverse direction y which extends perpendicularly to the longitudinal direction x is also orientated horizontally in the vehicle and extends parallel with a transverse vehicle direction. A vertical direction z extends perpendicularly to the longitudinal direction x and perpendicularly to the transverse direction y. In a vehicle seat 100 fitted in the vehicle, the vertical direction z extends parallel with the vertical vehicle axis.

The positional and directional indications used, such as, for example, front, rear, top and bottom, relate to a viewing direction of an occupant sitting in the vehicle seat 100 in a normal seat position, wherein the vehicle seat 100 is fitted in the vehicle, is orientated in a position for use suitable for conveying persons with an upright backrest 104 and is orientated as conventional in the travel direction. However, the vehicle seat 100 according to the invention can also be fitted in a different orientation, for example, transversely relative to the travel direction.

The positional indications and directional indications used, such as, for example, front, rear, top, bottom and transverse, relate to a viewing direction of an occupant sitting on a seat face of a seat substructure 102 of the vehicle seat 100 in a normal seat position, wherein the vehicle seat 100 is fitted in the vehicle in a position for use suitable for conveying persons and with an upright backrest 104, and is orientated as conventional in the travel direction. However, the vehicle seat 100 can also be fitted in a different orientation, for example, transversely relative to the travel direction. Unless otherwise described, the vehicle seat 100 is constructed in a mirror-symmetrical manner relative to a plane which extends perpendicularly to the transverse direction y.

The vehicle seat 100 has the seat substructure 102 and the backrest 104 which is articulated to the seat substructure 102 by two fittings 106 so as to be adjustable in terms of inclination. In this instance, the backrest 104 is in the form of a so-called buckling backrest, that is to say, the backrest 104 has a plurality of backrest portions which are connected to each other in an articulated manner. Such a divided backrest is known, for example, from DE 689 02 020 T2. However, the invention is not limited to vehicle seats with buckling backrests.

The vehicle seat 100 may be in the form of a so-called seat with an integrated belt, wherein a belt system is substantially completely integrated in the vehicle seat 100. In this case, an upper belt outlet point can be integrated in an upper region of the backrest 104. However, the invention is not limited to seats with an integrated belt.

The seat substructure 102 has a base 110, a seat frame 120 and an adjustment kinematic system 140 which acts between the base 110 and the seat frame 120.

In this instance, the base 110 is a longitudinal adjuster which has at both sides a seat rail 112 and a floor rail 114 which can be connected to a vehicle floor and on which the seat rail 112 is displaceably guided. At both sides, an adapter 116 is secured to the seat rail 112, respectively. The adapter 116 is particularly used to connect elements of the adjustment kinematic system 140 to the base 110.

The seat frame 120 comprises (when viewed in the transverse direction y) at both sides a seat frame side portion 122. Furthermore, the seat frame 120 has a front transverse tube 124 and a rear transverse tube 126. The two seat frame side portions 122 are arranged with spacing from each other. The front transverse tube 124 extends between the two seat frame side portions 122 and is securely connected to one of the two seat frame side portions 122 at both sides. The rear transverse tube 126 extends between the two seat frame side portions 122 and is supported at both sides rotatably on one of the two seat frame side portions 122. The seat frame side portions 122 are in this case composed of a plurality of sheet metal portions which are connected to each other, preferably welded. Alternatively, however, one-piece seat frame side portions can also be used at both sides.

In this instance, the adjustment kinematic system 140 has (when viewed in the transverse direction y) at both seat sides a five-bar kinematic system. Since the two five-bar kinematic systems are mirror-symmetrical relative to each other, that is to say, each of five parallel rotation axes I, II, III, IV, V extends at both sides through a rotary articulation of the five-bar kinematic systems, the adjustment kinematic system 140 is described below as a five-bar kinematic system. In this case, all the rotary articulations occur twice, that is to say (when viewed in the transverse direction y), once on a right side of the seat and once on a left side of the seat of the vehicle seat 100. Unless otherwise described below, consequently, all the components of the adjustment kinematic system 140 are present both on the right side of the seat and on the left side of the seat.

The adjustment kinematic system 140 has at both sides a first front link 142, a second front link 144 and a rear link 146. The first front link 142 is articulated to the base 110, in this case the adapter 116 of the base 110, pivotably about a first rotation axis I. The second front link 144 is articulated to the first front link 142 pivotably about a second rotation axis II. The second front link 144 is articulated to the seat frame 120 pivotably about a third rotation axis III. The rear link 146 is articulated to the seat frame 120 pivotably about a fourth rotation axis IV. The rear link 146 is articulated to the base 110, in this case the adapter 116 of the base 110, pivotably about a fifth rotation axis V. The rotation axes I, II, III, IV, V extend parallel with each other and parallel with the transverse direction y. Each of the rotation axes I, II, III, IV, V extends with spacing from all the other rotation axes I, II, III, IV, V.

In order to perform a height adjustment function, the adjustment kinematic system 140 has a first actuation drive 160. A spacing between the base 110 and the seat frame 120 is adjustable by the first actuation drive 160. To this end, the adjustment kinematic system 140 is adjustable by actuating the first actuation drive 160 so that an angle α₁ between the first front link 142 and the base 110, an angle α₂ between the first front link 142 and the second front link 144, an angle α₄ between the seat frame 120 and the rear link 146 and an angle α₅ between the rear link 146 and the base 110 are variable, wherein an angle α₃ between the second front link 144 and the seat frame 120 remains constant as long as a second actuation drive 170 remains non-activated.

The two rear links 146 are connected in this instance to the rear transverse tube 126 in a rotationally secure manner, in particular welded. The rear transverse tube 126 and consequently the two rear links 146 are supported on the seat frame side portions 122 of the seat frame 120 pivotably about the fourth rotation axis IV.

The first actuation drive 160 has an electric motor 162, a gear mechanism 164, a spindle nut and a spindle 166. The spindle nut is a rotatable and drivable component of the gear mechanism 164 and is preferably arranged in a gear mechanism housing of the gear mechanism 164. The first actuation drive 160 connects the rear link 146 and the base 110 to each other in an angularly adjustable manner and preferably directly, that is to say, not via additional gear mechanism members of the adjustment kinematic system 140. To this end, the spindle 166 is articulated to the rear link 146 eccentrically relative to the fifth rotation axis V. The motor 162 and the gear mechanism 164 are securely connected to the adapter 116 of the base 110. The gear mechanism 164 has the spindle nut which can be driven by the motor 162 and in which the spindle 166 is screwed. By actuating the motor 162, the spindle nut rotates so that the spindle 166 is moved relative to the gear mechanism 164 and pivots the rear link 146.

In order to provide an inclined position of the seat frame 120 and the backrest 104, the adjustment kinematic system 140 has the second actuation drive 170. It is possible by the second actuation drive 170 to raise the seat frame 120 in the front region thereof and to pivot it about the fourth rotation axis IV. Using the second actuation drive 170, the angle as between the second front link 144 and the seat frame 120 is adjustable, but with the angle as between the rear link 146 and the base 110 remaining constant as long as the first actuation drive 160 remains non-activated. The backrest 104, which is articulated to the seat frame 120 by the fittings 106, is also pivoted backward with the seat frame 120, in this instance about the fourth rotation axis IV, so that the inclined position of the seat frame 120 and the backrest 104 and consequently of the vehicle seat 100 is provided.

In the inclined position, the seat frame 120 and the backrest 104 are each inclined backward with respect to an upright position about an axis parallel with the transverse direction y so that a partially horizontal position of the vehicle driver is enabled during autonomous driving operation. An upper leg angle of the vehicle driver is in the inclined position preferably 27 degrees ±3 degrees with respect to the longitudinal direction x. The upright position of the vehicle seat 100 corresponds to a seat adjustment, in which the vehicle driver can safely take over the driving of the vehicle when the autonomous driving operation is switched off.

The second actuation drive 170 has an electric motor 172, a gear mechanism 174, a spindle nut and a spindle 176. The second actuation drive 170 connects the seat frame 120 and the second front links 144 to each other in an angularly adjustable manner. To this end, the two second front links 144 are connected to each other by a connection tube 144.1. The connection tube 144.1 extends parallel but with spacing relative to the second rotation axis II and the third rotation axis III. The spindle 176 is connected to a radially projecting lever arm 144.2 of the connection tube 144.1 in an articulated manner. A spindle end of the spindle 176 is articulated to the connection tube 144.1 eccentrically relative to the second rotation axis II and eccentrically relative to the third rotation axis III. The spindle 176 is thereby articulated to the second front links 144 eccentrically relative to the second rotation axis II and eccentrically relative to the third rotation axis III. The connection tube 144.1 is arranged in front of the front transverse tube 124. The gear mechanism 174 is pivotably articulated to the front transverse tube 124.

In order to provide a seat face inclination adjuster, the vehicle seat 100 has a third actuation drive 180. A seat face upholstery carrier (not illustrated in the figures) carries an upholstery member which has a seat face for an occupant of the vehicle seat 100. It is possible by the seat face inclination adjuster to adjust an angle between the seat face and the longitudinal direction x without changing the angle of the backrest 104 relative to the vertical direction z.

The third actuation drive 180 has an electric motor 182, a gear mechanism 184, a spindle nut and a spindle 186. The third actuation drive 180 connects the seat frame 120 and a support tube 188 to each other in an angularly adjustable manner and preferably directly, that is to say, not via additional gear mechanism members. In this case, the support tube 188 is eccentrically articulated to the seat frame 120 pivotably about the third rotation axis III by two metal bearing sheets 188.1. The spindle 186 is connected in an articulated manner to a radially projecting lever arm 188.2 of the support tube 188.

In a modification of the exemplary embodiment, however, the support tube may also be pivotable about another rotation axis.

The seat face upholstery carrier is, for example, a seat shell, in particular made of a deep-drawn metal sheet or a plastics material. The seat face upholstery carrier is articulated to the seat frame 120 pivotably about a sixth rotation axis VI. Furthermore, the seat face upholstery carrier is pivotably positioned on the support tube 188. The support tube 188 is (when viewed in the longitudinal direction x) arranged in front of the sixth rotation axis VI.

In that the seat face upholstery carrier is articulated to the seat frame 120 pivotably about the sixth rotation axis VI and the support tube 188 is pivotable by the third actuation drive 180 eccentrically relative to the seat frame 120, in this instance about the third rotation axis III, an angle between the seat face upholstery carrier and consequently the seat face and the seat frame 120 is adjustable by the third actuation drive 180.

A fourth actuation drive 190 serves to longitudinally adjust, that is to say, to displace, the seat rail 112 relative to the floor rail 114. The fourth actuation drive 190 has in a manner known per se an electric motor 192, a gear mechanism, a spindle nut and a spindle.

The vehicle seat 100 is substantially mirror-symmetrical relative to a plane which extends perpendicularly to the transverse direction y and has in particular at both sides a first actuation drive 160, a second actuation drive 170 and a fourth actuation drive 190. The third actuation drive 180 is (when viewed in the transverse direction y) arranged centrally and only present once. In modifications of the exemplary embodiment, one or more of the other actuation drives 160, 170, 190 may also be present only at one side.

A second exemplary embodiment which is not illustrated in the figures corresponds to the above-described exemplary embodiment illustrated in the figures except for the differences described below. The vehicle seat of the second exemplary embodiment also has a first actuation drive having an electric motor, a gear mechanism, a spindle nut and a spindle. However, the motor and the gear mechanism are, unlike the above-described exemplary embodiment, not connected to the adapter of the base, but instead to a seat frame side portion.

A third exemplary embodiment which is not illustrated in the figures corresponds to the above-described exemplary embodiment illustrated in the figures except for the differences described below. In the vehicle seat of the third exemplary embodiment, however, the connection tube which connects the two second front links is arranged behind the front transverse tube. In a modification of the third exemplary embodiment, the motor and the gear mechanism of the first actuation drive are further, as in the second exemplary embodiment, connected to a seat frame side portion.

The features which are disclosed in the above description, claims and figures may be significant both individually and in combination for carrying out the invention in its various embodiments as long as they remain within the protective scope of the claims.

### LIST OF REFERENCE NUMERALS

100 Vehicle seat
102 Seat substructure
104 Backrest
106 Fitting
110 Base
112 Seat rail
114 Floor rail
116 Adapter
120 Seat frame
122 Seat frame side portion
124 Front transverse tube
126 Rear transverse tube
140 Adjustment kinematic system
142 First front link
144 Second front link
144.1 Connection tube
144.2 Lever arm
146 Rear link
160 First actuation drive
162 Electric motor
164 Gear mechanism
166 Spindle
170 Second actuation drive
172 Electric motor
174 Gear mechanism
176 Spindle
180 Third actuation drive
182 Electric motor
184 Gear mechanism
186 Spindle
188 Support tube
188.1 Metal bearing sheet
188.2 Lever arm
190 Fourth actuation drive
192 Electric motor
α₁ Angle
α₂ Angle
α₃ Angle
α₄ Angle
α₅ Angle
I First rotation axis
II Second rotation axis
III Third rotation axis
IV Fourth rotation axis
V Fifth rotation axis
VI Sixth rotation axis
x Longitudinal direction
y Transverse direction
Z Vertical direction

1-15. (canceled)

16. A vehicle seat, comprising: a seat substructure and a backrest which is articulated to the seat substructure, the seat substructure having a base, a seat frame and an adjustment kinematic system which acts between the base and the seat frame for performing a height adjustment function and for moving the seat frame and the backrest into an inclined position, wherein the adjustment kinematic system is in the form of a five-bar kinematic system having a first front link, a second front link and a rear link, wherein the first front link is articulated to the base pivotably about a first rotation axis, the second front link is articulated to the first front link pivotably about a second rotation axis, the second front link is articulated to the seat frame pivotably about a third rotation axis, the rear link is articulated to the seat frame pivotably about a fourth rotation axis and the rear link is articulated to the base pivotably about a fifth rotation axis, wherein the adjustment kinematic system, has a first actuation drive for performing the height adjustment function and has a second actuation drive for moving the seat frame and the backrest into the inclined position, wherein, in order to move the seat frame and the backrest into the inclined position by the second actuation drive, an angle between the second front link and the seat frame is variable, wherein the second actuation drive has an electric motor, a gear mechanism, a spindle nut and a spindle.

17. The vehicle seat as claimed in claim 16, wherein the spindle of the second actuation drive is articulated to the second front link eccentrically relative to the second rotation axis.

18. The vehicle seat as claimed in claim 16, wherein the spindle of the second actuation drive is articulated to the second front link eccentrically relative to the third rotation axis.

19. The vehicle seat as claimed in claim 16, wherein the third rotation axis is arranged in front of the second rotation axis.

20. The vehicle seat as claimed in claim 16, wherein the third rotation axis is arranged above the second rotation axis.

21. The vehicle seat as claimed in claim 16, wherein the third rotation axis is arranged in front of the first rotation axis.

22. The vehicle seat as claimed in claim 16, wherein a spacing between the second rotation axis and the third rotation axis is greater than a spacing between the first rotation axis and the second rotation axis.

23. The vehicle seat as claimed in claim 16, wherein the electric motor of the second actuation drive and the gear mechanism of the second actuation drive are arranged completely below the third rotation axis.

24. The vehicle seat as claimed in claim 16, wherein when changing the seat frame and the backrest into the inclined position, an inclination angle of the seat face relative to the vertical direction is changed by the same amount as an inclination angle of the backrest relative to the vertical direction.

25. The vehicle seat as claimed in claim 16, wherein the first actuation drive has an electric motor, a gear mechanism, a spindle nut and a spindle.

26. The vehicle seat as claimed in claim 25, wherein the electric motor of the first actuation drive and/or the gear mechanism of the first actuation drive are arranged in front of the fourth rotation axis.

27. The vehicle seat as claimed in claim 16, wherein the first actuation drive connects the rear link and the base to each other directly in an angularly adjustable manner.

28. The vehicle seat as claimed in claim 16, wherein for providing a seat face inclination adjuster, a seat face upholstery carrier is pivotably articulated to the seat frame about a sixth rotation axis and an angle between the seat face upholstery carrier and the seat frame is adjustable by a third actuation drive

29. The vehicle seat as claimed in claim 16, wherein the base has an adapter and the adapter is formed or secured on a seat rail of a base which is in the form of a longitudinal adjuster.

30. The vehicle seat as claimed in claim 16, wherein the longitudinal adjuster has at least one seat rail and a floor rail which can be connected to a vehicle floor and on which the seat rail is displaceably guided, and has a fourth actuation drive for displacing the seat rail relative to the floor rail.
